(19) United States
(12) Patent Application Publication
(10) Pub. No.: US 2007/0076689 A1
(43) Pub. Date: Apr. 5, 2007

(54) Forward and backward reproduction of a signal from stream data

(75) Inventors: Arnoldus Werner Johannes Oomen, Eindhoven (NL); Fransiscus Marinus Jozephus De Bont, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/576,162

(22) PCT Filed: Oct. 11, 2004
(86) PCT No.: PCT/IB04/52049

§ 371 Date: Apr. 14, 2006

(30) Foreign Application Priority Data
Oct. 24, 2003 (EP) 03103954.8

(51) Int. Cl. H04L 12/66

(52) U.S. Cl. 370/352

(57) ABSTRACT

A data stream contains segments with reproducible signal data that has been encoded with a variable length encoding scheme. Each segment also contains first and second information about the length of the signal data in the segment, stored at predetermined relative positions with respect to the start and end of the signal data in the particular segment. During replay access locations are computed for accessing a next succeeding or preceding segment adjacent to a particular segment when a forward and backward direction of replay are selected respectively. The access location is computed from the first information from the particular segment or the second information from the adjacent segment that precedes the particular segment, dependent on whether the forward or backward direction is selected respectively.

The invention generally relates to reproduction of a signal from stream data in a storage medium, and in particular to a method and apparatus for storing a stream of data in such a medium, a method and apparatus for reproducing such a stream and a medium carrying such a stream.

PCT patent application WO 02/086894 describes a technique for reproducing stored stream data. Stored stream data containing signal data such as audio or video data is intended for temporally sequential reproduction of a signal. In conventional uncompressed stream data, such as a set of samples of a signal that have been taken at regularly spaced sampling times, a frame of data with a given size represents a predetermined duration of the signal. However, in order to reduce the amount of data that is needed to represent the stream, the data is often compressed by means of variable length compression. The compressed data is stored in frames, that represent a predetermined duration of data, but whose length depends on the amount of compression and thereby on the data itself. Typically, the length of the frame is indicated in the frame header. This makes it easy to navigate through frames in the normal order. However, it is difficult to retrieve the frames in any but the normal order of reproduction of the stream, e.g. in reverse order.

PCT patent application WO 02/086894 describes that an MP3 stream contains variable length data frames and headers. The headers occur at regular distances from one another and are not necessarily immediately followed by the start of a frame. Instead each header contains a pointer to the start of an associated frame. In this case the distance between the headers is fixed (Constant Bit Rate mode), and it is possible to realize forward and backward reproduction by jumping regular distances from header to header and using the pointers from the headers to locate the start of the data frames. However, such a technique complicates editing (adding or removing frames). Retrieval is also complicated by the lack of a fixed relation between headers and frames (Variable Bit Rate mode). Moreover, problems occur during reverse play if the distance between headers does change.

PCT patent application WO 02/086894 describes how this problem can be solved by temporarily storing the stream so that each frame starts at a predetermined distance from the start of the next adjacent frame. Thus, the start addresses of the frames can be computed in advance, without information about the content of the stream, making it possible to retrieve frames in any order without searching. However, this technique requires additional storage space and time to pre-process the stored data stream before the stream can be reproduced.

Another possible technique to is to compile a table of start addresses of frames and to use these addresses to locate the frames in any order. However, this technique implies that the table must be updated when the stream is edited (i.e. when frames are removed from or added to the stream for example).

Among others, it is an object of the invention to provide for simplified reproduction of a stream of data from a storage medium in an arbitrarily selectable direction of reproduction, without requiring a search for the start of frames or a table of start addresses.

More particularly, it is an object of the invention to provide for a method and apparatus to reproduce a stream of data from a storage medium in such a way that no search is required during reproduction.

More particularly, it is another object of the invention to provide for a method and apparatus to store a stream of data in a storage medium in such a way that no search will be required during reproduction. Furthermore, it is another object of the invention to provide for a storage medium in which a stream is stored in such a way that no search will be required during reproduction.

The invention provides for methods, apparatuses and storage media as set forth in the claim. According to the invention two items of length information are included in a variable length segment of a stream that stores stream data: first information that is stored in the segment at a predetermined (i.e. stream data independent) position relative to the start of the stream data and second information that is stored in the frame at a predetermined position relative to the end of the stream data A segment is for example a frame, or a group of frames that includes a variable length frame with signal data, followed by a frame with information about the length of the frame with signal data.

During forward reproduction the first information is read and used to locate the start of the next segment. During backward reproduction, when a particular frame is accessed, the end of the next preceding segment is accessed to receive the second information from that next preceding segment and used to locate the start of the next preceding segment. Preferably, the stream data is rendered (e.g. displayed as video data, or auditively reproduced as audio data) while the stream is reproduced in forward or backward direction. However, as used herein the word “replay” is not limited to simultaneous rendering. For example it also includes includes regeneration of the data followed by storage of the replayed data without immediate rendering.

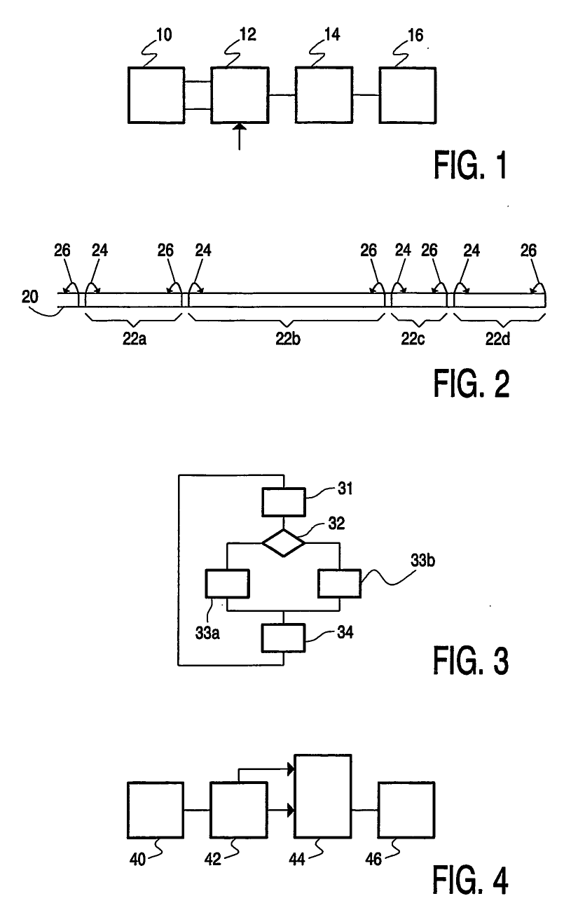

These and other objects and advantageous aspects of the invention will be described in more detail by means of non-limiting examples using the following figures
FIG. 1 shows a stream reproduction apparatus
FIG. 2 symbolically shows a stream
FIG. 3 shows a flow-chart of a method of reading a stream
FIG. 4 shows a stream storage apparatus

FIG. 1 shows a stream reproduction apparatus. The apparatus contains a storage device 10 (for example a tape drive or a disk drive), a read control device 12, a decoder 14 and a rendering device 16, coupled in cascade. In operation, read control device 12 sends addresses to storage device 10 to retrieve selected data from stored data that represents a stream of data. Storage device 10 retrieves the addressed data and sends it to read control device 12, which transmits encoded stream data to decoder 14. Decoder decodes the stream data and passes the decoded data to rendering device 16, which renders the data in the form of an audio or video signal for example.

FIG. 2 symbolically shows a stream 20 stored in storage device 10. Data is stored in frames 22a-d, represented from left to right according to the temporal sequence of reproduction during normal play. As can be seen frames 22a-d may have mutually different lengths, dependent on the encoded data In case of an audio stream for example, each frame may correspond to a predetermined time interval of audio signal, the length of the frame depending on the amount of data needed to represent the audio signal with compressed data for that time interval.

Each frame 22a-d contains two length codes, stored at a predetermined distance relative to the start and the end of the frame 22a-d respectively. The predetermined relations between the start of the frame and the storage location of a first length code are symbolized by arrows 24. The predetermined relations between the end of the frame and the storage location of the second length code are symbolized by arrows 26. For the sake of illustration gaps of fixed size are shown between the starting point and the end point of the frames, but it will be understood that the frames are usually stored with the start of each frame 22a-d directly adjacent the end of the preceding frame 22a-d.

The length codes may take any form, such as numbers that directly represent the length in bytes, or the length in terms of larger units, such as 32 or 64 bit words. Also length codes referring to length entries in a translation table may be used etc. Similarly, an absolute jump address may be used, so that the length follows indirectly from the difference between the jump address and the address where the jump address is stored. Any predetermined position relation between the start and end of the signal data may be used, e.g. directly in front of or behind a fixed length information item that always precedes or follows any signal data. Preferably, the predetermined position relation is selected so that no other signal data, which is described by other length codes, is present between any length code and the signal data that is described by the length code. This makes it easy to edit the stream by adding or deleting self-contained coherent segments of the stream with signal data and length code.

In a further embodiment stream 20 may be made up of frames of different types, including frames with signal data and frames with auxiliary data. In this case at least the second length code of a frame may be stored in dedicated frames, which occur each time just before the end of a next frame with signal data. In this embodiment the first length code may be stored in a header of each frame of signal data, or in a separate frame as well. Also, groups of variable length frames with signal data may be used, followed by a frame with the second length code, but without such frames with length codes between different frames of the group. Thus a jump over a segment may be realized that contains a group at a time.

The frames (independent of whether they are frames with signal data and both length or mixed frames with signal data and length codes respectively) may be grouped into blocks for encryption and decryption. Preferably, fixed length blocks are used that may contain a variable number of variable length frames. In this case it is preferably ensured that, when signal data is included in a block, both length codes are included in the block as well. Thus, editing (adding and deleting of blocks) may be performed at the block level, without affecting the reproducibility.

FIG. 3 shows a flow-chart of reproduction of the stream. In a first step 31 read control device 12 determines the start point of a current frame 22a-d and detects a direction control signal (received for example from a user control input). In a second step 32 read control device tests whether forward or backward reproduction is required. When the direction control signal signals forward reproduction read, control device 12 executes a first version of a third step 33a, in which it reads the first length code form the current frame 22a-d from the predetermined position relative to the start of the current frame 22a-d. When the direction control signal signals backward reproduction, read control device 12 executes a second version of a third step 33b, in which it reads the second length code from the frame 22a-d that directly precedes the current frame 22a-d from the predetermined position relative to the end of the frame that directly precedes the current frame 22a-d. Since there is a fixed relation between the start of the current frame and the end of the directly preceding frame, there is also a predetermined relation between the start of the current frame and the location of the second length code in the directly preceding frame. This relation may be used to retrieve the second length code.

In a fourth step 34 read control device 12 uses the retrieved length code to determine the start location of the next frame that will become the current frame, i.e. using the first or second length code, dependent on the selected direction of reproduction, to determine the start location of the next following frame or the directly preceding frame relative to the current frame. Read control device 12 reads this frame and supplies the encoded data from the frame to decoder 14 for decoding. After this the flow-chart repeats from the first step.

This is the case for reproduction at normal speed. When reproduction at a higher speed is required, it may be necessary to skip frames, in which case read control device 12 reads encoded data only from selected ones of the frames.

FIG. 4 shows an apparatus for storing a stream of data. The apparatus contains a stream source 40, an encoder 42, a write control unit 44 and a storage device 46. In operation source 40 supplies a stream, encoder 42 encodes the stream in frames of variable length and outputs frame data and length data to write control device 44. Write control device 44 causes storage device 46 to store the frame data, as well as at least two length codes with each frame, a first one at a predetermined location relative to the start of the frame and second one at a predetermined location relative to the end of the frame.

1. A reproduction apparatus for replaying a signal encoded in a stream of data, the apparatus comprising
an interface to a storage medium (10), for reading data from the storage medium (10), the storage medium (10) storing segments (22a-d) of data of variable length, each particular segment (22a-d) containing reproducible signal data from the stream encoded with a variable length encoding scheme and first and second information about the length of the signal data in the particular segment (22a-d), stored at predetermined relative positions with respect to the start and end of the signal data in the particular segment (22a-d);
a control input for receiving a selection of a direction of replay;
an access location computation unit (12), arranged to compute an access location in the storage medium (10), for accessing a next succeeding or preceding segment (22a-d) adjacent to a particular segment (22a-d) when a forward and backward direction are selected respectively, the computation unit (12) computing the access location from the first information from the particular segment (22a-d) or the second information from the adjacent segment (22a-d) that precedes the particular segment (22a-d), dependent on whether the forward or backward direction is selected respectively.

2. A method of reading signal data from stream data stored in a storage medium (10) for replay of the signal data in a selectable play direction, wherein the stream data is stored in the storage medium (10) as a sequence of segments (22a-d) of variable length, each particular segment (22a-d) comprising reproducible signal data encoded with a variable length encoding scheme and first and second information about the length of the signal data in the particular segment (22a-d), stored at predetermined relative positions with respect to the start and end of the signal data in the particular segment (22a-d), the method comprising retrieving the first and second information to access adjacent segments (22a-d) for computing access locations during replay in a forward and backward play direction respectively.

3. A method of storing stream data containing reproducible signal data in a storage medium (46), wherein the stream data comprises a sequence of segments (22a-d) of variable length, each segment (22a-d) comprising signal data encoded with a variable length encoding scheme, the method comprising storing first and second information about the length of the signal data in each particular segment (22a-d) in the particular segment (22a-d) at predetermined relative positions with respect to a start and an end of the signal data of each of said particular segment (22a-d) respectively.

4. A method according to claim 3, comprising encrypting the stream in individually decryptable blocks of predetermined length and including a respective number greater than one of said segments (22a-d) in each block, the respective numbers being selected dependent on the length of the segments (22a-d), each particular block containing the first and second information of all segments (22a-d) in the particular block.

5. A method according to claim 3, comprising storing a plurality of frames in each segment (22a-d), including a variable length first frame containing signal data and a second frame with said second information, following the first frame.

6. An apparatus for storing stream data containing reproducible signal data in a storage medium (46), wherein the stream data comprises a sequence of segments (22a-d) of variable length, each segment (22a-d) comprising signal data encoded with a variable length encoding scheme, the apparatus being arranged to store first and second information about a length of the signal data in each particular segment (22a-d) in the particular segment (22a-d) at predetermined relative positions with respect to a start and an end of the signal data in the particular segment (22a-d) respectively.

7. A medium carrying a stream data containing signal data for time sequential reproduction, wherein the stream comprises a sequence of segments (22a-d) of variable length, each segment (22a-d) comprising signal data encoded with a variable length encoding scheme, each particular segment (22a-d) containing first and second information about the length of the signal data in the particular segment (22a-d) at predetermined relative positions with respect to a start and an end of the signal data in the particular segment (22a-d) respectively.

8. A medium according to claim 7, comprising individually decryptable encrypted blocks of predetermined length, each including a respective number of said segments (22a-d), each block containing the first and second information of all segments in the block.

9. A medium according to claim 7, comprising a plurality of frames in each segment (22a-d), the frames in each segment (22a-d) including a variable length first frame containing signal data and a second frame with said second information, following the first frame.
